(19) United States
(12) Patent Application Publication
(10) Pub. No.: US 2004/0253359 A1
(43) Pub. Date: Dec. 16, 2004

(54) Process for adding microbiologically safe chocolate particulates to yogurt

(76) Inventors: Anthony Michael Rettinger, Monterey, CA (US); John P. Hansen, Wadsworth, OH (US); James Andrew Jindra, Wooster, OH (US); Mark Stephen Grucza, Wadsworth, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/815,305

(22) Filed: Apr. 1, 2004

Related U.S. Application Data
(60) Provisional application No. 60/459,326, filed on Apr. 1, 2003.

(51) Int. Cl. A23G 1/00

(52) U.S. Cl. 426/583

(57) ABSTRACT

Method of adding lipid-based inclusions, particularly chocolate, to yogurt are provided. The methods of the present invention comprising the steps of providing a filling, the filling having a pH of less than 4.6; and adding the lipid-based inclusions to the filling. In a preferred embodiment, the lipid-based inclusions are formed by the steps of providing a filling, wherein the filling has a pH of 4.6 or less; chilling the filling to a temperature below the temperature required to crystallize the lipid-based inclusions; providing a lipid-based melt that will form the inclusions when crystallized; injecting the lipid-based melt into the chilled filling; allowing the lipid-based melt to at least partially solidify in the chilled filling; and agitating the mixture of step e to form the lipid-based inclusions in the filling. In accordance with the methods of the present invention, the lipid-based inclusions maintain physical integrity and microbiological stability when the filling is incorporated into yogurt.

### CROSS-REFERENCE TO RELATED APPLICATIONS

This application claims priority to U.S. Provisional Patent Application No. 60/459,326, filed Apr. 1, 2003, the entirety of which is incorporated herein by reference.

### BACKGROUND OF THE INVENTION

It would desirable to add pieces of chocolate to either the yogurt filling or directly to yogurt while maintaining a safe product with the same shelf life as the current yogurt products. However, it is also desirable that this chocolate inclusion can be added at a reasonable cost to the yogurt manufacturer and to the consumer.

There are several issues and problems encountered in attempting to add chocolate particulates to fillings or to commercial yogurt.

Industry standard practice requires that all fillings and inclusions within yogurt be void of viable vegetative microorganisms, i.e. they must be commercially sterile, to achieve the desired safety and shelf life. Currently, sterile fillings are prepared by intervention methods that destroy such microorganisms. The most common intervention method used today is thermal pasteurization, which yields aseptic fruit fillings that may then be added to yogurt.

Chocolate is made up of components that inherently contain relatively high microbiological loads. Cocoa beans, from which chocolate is made, are grown in the tropical regions of the world. The process for making chocolate begins by cutting cocoa pods from the tree, breaking the pods open, and harvesting the cocoa beans from the pod. The cocoa beans are then subjected to a fermentation process that is essential for developing the taste, aroma and color of the chocolate. This fermentation process leaves the cocoa bean with high levels of microorganisms and spores. After the beans have been fermented, dried and cleaned, the first step in the chocolate manufacturing process is roasting of the cocoa beans. Roasting further reduces moisture and develops the rich brown color and characteristic flavor and aroma. Roasting is also the primary means of microbiological contol of the cocoa bean or chocolate nib raw material. The shell of the bean is then separated and removed exposing the cocoa “nib”, that is the basis for all chocolate products. The nibs, which contain approximately 53% cocoa butter, is then crushed and ground to yield a liquid material called chocolate liquor. The chocolate liquor may further be pressed to yield cocoa cake and cocoa butter. Cocoa butter is solid at room temperature and melts at 90 to 93° F. The cocoa butter may be combined with chocolate liquor, sugar, milk, salt, and perhaps vanilla, cocoa and lecithin to make eating chocolate. Cocoa cake may be ground to make cocoa powder. Cocoa powder may be used to make chocolate flavored foods such as chocolate ice cream, chocolate milk, chocolate frosting, chocolate compound coatings, etc. The process for making chocolate does not utilize sufficient heat to kill all the microorganisms.

In order to call a product Chocolate, chocolate manufactures are held to a strict set of standards, which has been set forth by the U.S. Food and Drug Administration. These Standards of Identity spell out the chocolate formulations for the various chocolate products. The minimum content of milk and chocolate liquor are examples of standards for chocolate.

The composition of any given chocolate formula is set out by the minimum standards for the type of chocolate desired. Dark, semisweet, or bitter-sweet chocolate must contain not less than 35% dry cocoa solids from chocolate liquor. Light-sweet chocolate must contain not less than 15% dry cocoa solids from chocolate liquor. Milk chocolate must contain not less than 10% dry cocoa solids from chocolate liquor, not less than 12% total milk solids, and not less than 3.39% butterfat. Cocoa butter, and butterfat in the case of milk chocolate, are the only forms of fat allowed in milk chocolate in the United States. Regulations for chocolate differ for different countries around the world. Some countries allow addition of cocoa butter equivalents (CBE) to their chocolate. CBEs are vegetable, non-hydrogenated products with similar characteristics to cocoa butter. Some countries allow cocoa butter replacements (CBR) or cocoa butter substitutes (CBS) to chocolate. CBRs and CBSs range from natural or hardened lauric fats (coconut and palm kernel oils) to specially fractionated or derived vegatable oils. There has been much debate as to the level of cocoa butter substitution with CBEs, CBRs, or CBSs which are generally used for their economic and technical advantages.

A compound chocolate is another method for making chocolate “flavored” inclusions. Compound chocolate is generally made with cocoa powder, sugar, and vegetable shortenings like coconut oil, fractionated palm kernal oil, hydrogenated oils such as soybean or cottonseed or combinations of the above and vanillin. Compound chocolate has economic advantages over standard of identity chocolate because cocoa butter costs more than vegetable oils. The melting point characteristics of the fats used in compound chocolate may also affect the flavor delivery in frozen or refrigerated products. The lower the melt point, the quicker the flavor release when dissolved in the mouth. An alkanization process to the cocoa nibs, chocolate liquor, or cocoa may also affect the compound chocolate flavor and color. The compound chocolate coatings are used to coat ice cream cone coatings and many enrobed cookies, bars and snacks.

Compound chocolate may also be made in a sugar free form. Formulations for sugar free would likely include the addition of polyols as the primary sweetener instead of sugar or dextrose i.e. maltitol, erythritol, mannitol, or sorbitol. They could also use high intensity sweeteners like aspartame, sucralose, or acelsufame potassium to enhance the sweetness further. Other ingredients could be delactosed milk protein, salt, vanillin and lecithin.

Chocolate is not the only flavor of inclusion that may be formulated in this way. Using an approach similar to compound chocolate, alternate flavors may be achieved by replacing the cocoa solids with that of dried or powdered fruits or flavors, sugar, acids, salt, etc. They would likely use some other fat or oil as opposed to cocoa butter like coconut oil, fractionated palm kernal oil, hydrogenated vegetable oils, etc. Examples of other flavored compounds could be butterscotch, caramel, strawberry, or vanilla and others flavored inclusions.

Chocolate and cocoa based compound chocolate will inherently contain some microbiological organisms from the cocoa and milk ingredients yet will not spoil by it self. The formulation for chocolate and compound chocolate is essentially a dispersion or suspension of solids i.e. cocoa, sugar, milk, etc., within the cocoa butter or vegetable oil matrix. Because the chocolate and compound chocolate formulation contains essentially no water, microbes cannot grow. Water is essential for the microorganisms to germinate and grow. If chocolate or compound chocolate is added to a product that has sufficient moisture, microbiological spoilage could occur in that product.

Many food products utilize chocolate as an ingredient without microbiological safety concerns or jeopardization of the shelf life. For example, ice creams that contain chocolate inclusions are maintained in a frozen state, thereby preventing germination or growth of microorganisms. Cookie mixes do not have sufficient moisture to initiate microbiological growth. Baked goods undergo a thermal pasteurization.

Yogurt is a dairy product made through the fermentation of milk using safe strains of bacteria. Prior to culturing, the milk is pasteurized to eliminate any unwanted or unsafe microorganisms. The milk substrate is very nutritious from a bacterial growth standpoint. The yogurt cultures used to ferment yogurt are generally a cocktail of purified strains of bacteria, including some lactic acid producing bacteria, which are essential to the finished product pH and the safety of the yogurt. Introduction of other bacteria, mold, or yeast microorganisms, by way of an un-pasteurized ingredient, could cause spoilage of the yogurt thereby prematurely reducing the shelf life.

Another major problem with adding chocolate pieces to aseptic fillings is the fact that chocolate melts at 80-90° F. If chocolate is added to a fruit filling or flavor base the temperature of the filling or flavor base needs to be kept colder than the melting temperature of the chocolate or compound chocolate. If not, the chocolate will lose its identity and become homogenous with the filling. The filling or flavor base is required to be heat treated to yield it aseptic.

There are additional issues involved with just adding chocolate pieces directly to the yogurt. Methods that have been used to add aseptic chocolate to yogurt have required the chocolate first to be sterilized at a high temperature, and then be maintained in an aseptic environment from the time of sterilization to the time the chocolate is added to the yogurt. The process to accomplish this, however, is complex and the equipment cost is prohibitive.

The chocolate inclusion for addition to yogurt filling or yogurt may be contaminated by the ingredients used to make the chocolate or compound chocolate i.e. the chocolate liquor, cocoa, milk, etc. The chocolate or compound chocolate may also be contaminated by through the process of adding or injecting the chocolate in a non-sterile manner. If the chocolate is not pasteurized and is just warmed to melted temperature of about 90 to 120° F. prior to injection into a very cold filling or yogurt, microbes from the surroundings and equipment may be a source of environmental contamination. Even if the chocolate is pasteurized to eliminate or reduce the microbiological load from the chocolate ingredients prior to injection and then cooled to about 90 to 100° F. for injection into very cold filling, the same environmental contamination may occur to the filling. In some cases pasteurized fillings may see a rise in the viable bacteria. The theory behind this phenomenon is that the heat applied to kill the bacteria also causes the bacterial spores to germinate and become viable microorganisms. To truly eliminate all bacteria, it may be necessary to re-pasteurize the chocolate a second time.

The step of pasteurizing the chocolate or chocolate compound may be desirable from the standpoint of reducing risk of microbial contamination but may not be essential. It has been discovered through microbe inoculated chocolate challenge studies that injecting contaminated chocolate into an acidic filling of about 4.2 pH and where the filling contains preservatives, harmful pathogens and other spoilage microorganisms are prevented from growth and in the case of pathogens have died off over the course of time generally 2 to 3 weeks. The lower the pH of the filling, the more hostile the environment for bacteria and pathogens. At pHs just below pH 4.6 bacteria and pathogens may not die off so quickly. At pH values below 4.0, as is commonly found in fruit fillings, the bacteria or pathogens will die off in a shorter period of time. Therefore, although it may be desirable to pasteurize the chocolate prior to the injection, it is not essential. Investment in the cost of equipment to perform the pasteurization of the chocolate or chocolate compound may not be essential.

Another method of adding chocolate to yogurt is to package non-sterile chocolate chips from chocolate manufacturer in separate sidecar package whereby the consumer can add and stir chocolate particulates into yogurt at time of consumption. This eliminates need for additional heat application to chocolate. The chocolate particulate integrity is not an issue when packaged separately which would then allow for increased sweetener solids in the chocolate to help overcome the sharp bitter taste. However, this method requires more packaging, as the chocolate and yogurt must be packaged separately. The increased packaging is expensive and creates additional waste compared to products that have only one package. Accordingly, it would be desirable to have a method of adding chocolate pieces to yogurt without the need for additional packaging.

### SUMMARY OF THE INVENTION

Methods of delivering microbiologically safe chocolate particles as an inclusion to yogurt are provided. It has become apparent that methods for delivery of microbiologically safe chocolate particles to yogurt applications may be accomplished in a number of different ways. First, chocolate inclusions may be added to pre-pasteurized acidic yogurt fillings or yogurt (Less than 4.6 pH) in a safe manner. The acidic nature of yogurt fillings or yogurt will provide an environment not conducive to the existence of pathogens. As long as the filling are below pH 4.6 or below 0.70 Aw, and preferably pasteurized, the chocolate inclusion into the filling will be safe given the microbiological contamination and the length of time the microbes are held in this environment.

The lipid-based inclusions used in the methods for the present invention may be made from a class of chocolate or compound chocolate or flavored compound coatings. In the case of chocolate, cocoa butter is the only form of lipid allowed. In the case of milk chocolate, butterfat is an additional lipid used at sufficient quantities to meet the standard of identity. Compound chocolate may include cocoa butter and lipids from vegetable sources other than cocoa butter such as coconut oil, palm kernel oil, soybean oil, cottonseed oil and others. Other edible oils, including, but not limited to cottonseed, canola, rapeseed, peanut, safflower, sunflower, coconut, palm, olive, butterfat, cocoa butter, tallow, lard, corn, and combinations thereof may also be employed. Flavored compound coatings refer to a class of non-chocolate lipid based inclusions. They may contain lipids from vegetable sources other than cocoa butter such as coconut oil, palm kernel oil, soybean oil, cottonseed oil and others. For simplicity, any reference to chocolate used in this document includes all aspects of the lipid-based inclusion above.

Methods of delivering microbiologically safe, chocolate particles as an inclusion to yogurt are provided. In one aspect of the present invention, a method for adding chocolate pieces to a flavored yogurt filling, such as a fruit filling, which may be added to yogurt like a conventional filling. The conventional yogurt filling is prepared and made in accordance to a typical aseptic process for acidic fillings with a pH of below 4.6 for yogurt. These fillings are aseptically processed to at least 190° F. for approximately 5 minutes and then cooled and packaged in an aseptic manner. The method comprises first heating a chocolate mixture to a temperature sufficient for pasteurization for a sufficient amount of time, cooling the chocolate to 85-90° F., chilling a yogurt filling to well below the temperature required to crystallize the cocoa butter or vegetable oil found in the chocolate or compound chocolate, and then injecting the stream of melted chocolate into the chilled yogurt filling in a clean manner, to form a chocolate containing flavored filling. In accordance with the present invention, the filling is preferably chilled to 50° F., more preferably 40° F., and more preferably 30° F. or below, before injecting the chocolate stream into the filling stream. The resulting chocolate inclusion contained in the flavored filling may be added to yogurt in the same manner as a conventional yogurt filling.

Another method of delivering microbiologically safe chocolate particulates as an inclusion to yogurt is provided. The conventional yogurt filling is prepared and made in accordance to a typical aseptic process for acidic fillings with a pH of below 4.6 for yogurt. The method requires melting the chocolate to a temperature above the melt point typically required to melt chocolate, and then injecting the liquefied chocolate into a chilled stream of pasteurized conventional yogurt filling. In accordance with the present invention, the filling is preferably chilled to 50° F., more preferably 40° F., and more preferably 30° F. or below, before injecting the chocolate stream into the filling stream. The resulting chocolate inclusion contained in the flavored filling may be added to yogurt in the same manner as a conventional yogurt filling.

A related method for adding chocolate pieces to yogurt comprises first heating the chocolate to a temperature sufficient to pasteurize the chocolate and then injecting the melted chocolate into a chilled stream of high solids sweetening-syrup mixture, such as high fructose corn syrup. The syrup mixture is processed in accordance with a typical aseptic process for yogurt fillings. The sweetening syrup may have a water activity level below 0.75 or 0.7 and may be stabilized or thickened using conventional thickening agents to suspend the chocolate inclusions. The mixture may additionally be acidified to below pH 4.6. If the syrup is below a water activity level of around 0.7, and or below pH 4.6, the chocolate may not be required to be pasteurized prior to injection into the cold sweetening mixture. The sweetening mixture may be flavored or remain unflavored for a generic neutral tasting yogurt filling. This method yields a concentrated chocolate slurry that may be added to yogurt as the flavor filling, as for a chocolate chip flavored yogurt, or may be added along with another flavored fillings, such as a fruit flavored filling.

The present invention also provides methods for adding pre-formed chocolate pieces to yogurt. The chocolate mixture may be first heated to a temperature sufficient for pasteurization for a sufficient amount of time, or may be heated to a temperature necessary for melting the lipid, then cooled to a temperature of about 85-90° F., In this method, the chocolate pieces may be formed by any method known for forming chocolate pieces including flakes, drops, chunks etc The chocolate pieces are generally formed on a belt within a cooling tunnel sized, and then packaged in bags. Alternatively formed chocolate inclusions may be cold pasteurized using irradiation or by freezing at a sufficiently low temperature for a sufficient period of time to cause the microorganisms to die off. The chocolate inclusions could then be added to an aseptic filling prior to addition of the filling to the yogurt, or could be added to the yogurt itself.

For a bittersweet chocolate inclusion taste, the chocolate mixture used in the methods of the present invention contains very little soluble solids so that it will not dissolve when in the yogurt. Accordingly, the chocolate contains very little to no sugar or salt. The chocolate used in accordance with the present invention preferably contains less than 20% and preferably less than 10% and even more preferable less than 5% sugar, by weight, and preferably little or no added salt. The texture of the chocolate inclusion maintains its brittle texture without becoming too soft or chewy. A preferred chocolate mixture in the present invention comprises a ratio of about 65% chocolate liquor and about 35% cocoa butter.

For a more a sweet chocolate or milk chocolate taste that appeals to many Americans, the chocolate composition may include lower levels of chocolate liquor, addition of sugar up to 35%, addition of milk powder up to about 10%, and about 50% to 60% cocoa butter. For a more American tasting compound chocolate, the composition may include up to 12% cocoa powder, up to 35% sugar and up to 10% milk powder and about 50% to 60% vegetable oil. The vegetable oils may include blends of coconut palm kernel and soybean oils. Oil blends may include lower melt point oil sources which will melt more readily in the mouth. Total soluble solids content should be maintained as low as possible to preserve the integrity of the inclusion, preferably below 40%, and more preferably below 30%, and more preferably below 20%. Lecithin may be added to regulate and optimize the viscosity of the chocolate for injection.

### BRIEF DESCRIPTION OF THE DRAWINGS

FIG. 1 depicts one method of adding chocolate bits to yogurt filling.

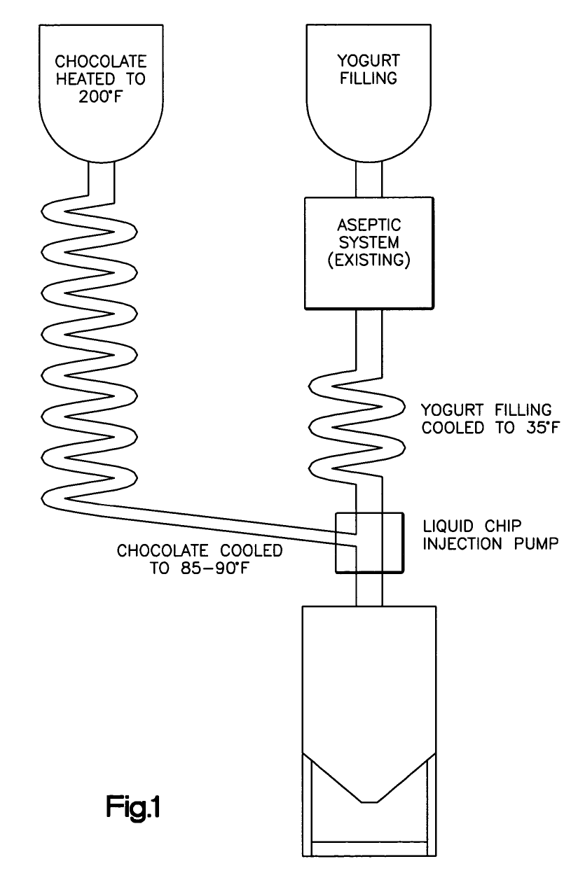

### DETAILED DESCRIPTION OF THE INVENTION

We have discovered two different methods for delivering safe chocolate pieces as a yogurt inclusion. The first method relates to the injection of melted chocolate or compound chocolate into a chilled aseptic pasteurized filling thereby forming chocolate particulates into an aseptic filling. The aseptic filling may be the fruit filling that will be added to the yogurt, or it may be an aseptic neutral flavored, stabilized sweetener blend consisting of chocolate particles in a non-fruit filling material, such as high fructose corn syrup. The second method involves first pre-forming chocolate flakes, bits, or pieces and adding it to the yogurt filling or to the yogurt. The preformed chocolate pieces may be made from chocolate that is just melted to a temperature of about 85 to 100° F., pre-pasteurized chocolate or they may be pasteurized by a cold method after the pieces have been formed., to prevent the chocolate from melting. Cold pasteurization methods that may be used include ozone pasteurization of pre-formed chocolate pieces, irradiation of the chocolate pieces, and freezing the pre-formed chocolate pieces for a sufficient time at a sufficient temperature to injure or cause destruction of the microorganisms in the chocolate. The ozone pasteurization at ambient temperatures may cause a bitter after taste to the chocolate particulates.

There are two key issues when adding chocolate to yogurt. The first is the microbiological stability and safety of the fillings and yogurt that the filling is added to—chocolate is made up of components that inherently contain relatively high microbiological loads. Chocolate and cocoa based compound chocolate will inherently contain some microorganisms from the cocoa and milk ingredients. The formulation for chocolate and compound chocolate is essentially a dispersion or suspension of solids i.e., cocoa, sugar, milk, etc within the cocoa butter or vegetable oil matrix. Because the chocolate and compound chocolate formulation contains essentially no water, microbes cannot grow. Therefore the micro stability and safety of chocolate is not an issue. Water is essential for the microorganisms to germinate and grow. If chocolate or compound chocolate is added to a product that has sufficient moisture, microbiological spoilage could occur in that product. Yogurt, unlike ice cream which may contain chocolate chips, is not maintained in a frozen state to prevent the growth of microorganisms that might arrive with the chocolate.

The chocolate inclusion for addition to yogurt filling or yogurt may be contaminated by the ingredients used to make the chocolate or compound chocolate i.e. the chocolate liquor, cocoa, milk, etc. The chocolate or compound chocolate may also be contaminated by through the process of adding or injecting the chocolate to the filling in a non-sterile manner. If the chocolate is not pasteurized and is just warmed to melted temperature of about 90 to 120° F. prior to injection into a very cold filling or yogurt, incidental microbes from the surroundings and equipment may be a source of environmental contamination. Even if the chocolate is pasteurized to eliminate or reduce the microbiological load from the chocolate ingredients prior to injection and then cooled to about 90 to 100° F. for injection into very cold filling, the same environmental contamination may occur to the filling. In some cases pasteurized fillings may see a rise in the viable bacteria. The theory behind this phenomenon is that the heat applied to kill the bacteria also causes the bacterial spores to germinate and become viable microorganisms. To truly eliminate all bacteria, it may be necessary to re-pasteurize the chocolate a second time.

The step of pasteurizing the chocolate or chocolate compound may be desirable from the standpoint of reducing risk of microbial contamination but may not be essential. It has been discovered through microbe inoculated chocolate challenge studies that injecting contaminated chocolate into an acidic filling of about 4.2 pH and where the filling contains preservatives, harmful pathogens and other spoilage microorganisms are prevented from growth and in the case of pathogens have died off over the course of time generally 2 to 3 weeks. The lower the pH of the filling, the more hostile the environment for bacteria and pathogens. At pHs just below pH 4.6 bacteria and pathogens may not die off so quickly. At pH values below 4.0, as is commonly found in fruit fillings, the bacteria or pathogens will die off in a shorter period of time. Therefore, although it may be desirable to pasteurize the chocolate prior to the injection, it is not essential. Investment in the cost of equipment to perform the pasteurization of the chocolate or chocolate compound may not be essential.

If chocolate or compound chocolate is added to fillings or yogurt or other products that contain water, other microbiological control agents may be employed to control the microbiological safety and spoilage of the food. An acidic environment within the filling or flavor base will prevent growth of pathogens. The acidic condition may also cause the pathogens to die off over time in this hostile environment. A filling or food with a water activity level of less than about 0.75 or 0.7 also provides an environment hostile to pathogens within the product. Preservatives such as potassium sorbate, sodium benzoate, sorbic acid, etc., may be employed to control the growth of spoilage organisms such as yeasts and mold.

The second key issue with adding chocolate to yogurt filling or yogurt is the ability to have acceptable taste and texture to the chocolate inclusion in the yogurt filling and yogurt. In order to maintain the physical integrity and texture of the chocolate particulate in the yogurt filling or finished yogurt, reduced levels of soluble solids are used to minimize their dissolution by the moisture within the product. A bittersweet chocolate taste is the result of the reduced sugar content. The present invention provides methods of adding chocolate pieces to yogurt while maintaining microbiological stability and preserving a sweet, desirable flavor of chocolate.

In order to call a product Chocolate, chocolate manufactures are held to a strict set of standards, which has been set forth by the U.S. Food and Drug Administration. These Standards of Identity spell out the chocolate formulations for the various chocolate products. The minimum content of milk and chocolate liquor are examples of standards for chocolate.

The composition of any given chocolate formula is set out by the minimum standards for the type of chocolate desired. Dark, semisweet, or bitter-sweet chocolate must contain not less than 35% dry cocoa solids from chocolate liquor. Light-sweet chocolate must contain not less than 15% dry cocoa solids from chocolate liquor. Milk chocolate must contain not less than 10% dry cocoa solids from chocolate liquor, not less than 12% total milk solids, and not less than 3.39% butterfat. Cocoa butter, and butterfat in the case of milk chocolate, are the only forms of fat allowed in milk chocolate in the United States. Regulations for chocolate differ for different countries around the world. Some countries allow addition of cocoa butter equivalents (CBE) to their chocolate. CBEs are vegetable, non-hydrogenated products with similar characteristics to cocoa butter. Some countries allow cocoa butter replacements (CBR) or cocoa butter substitutes (CBS) to chocolate. CBRs and CBSs range from natural or hardened lauric fats (coconut and palm kernel oils) to specially fractionated or derived vegatable oils. There has been much debate as to the level of cocoa butter substitution with CBEs, CBRs, or CBSs which are generally used for their economic and technical advantages.

A compound chocolate is another method for making chocolate “flavored” inclusions. Compound chocolate is generally made with cocoa powder, sugar, and vegetable shortenings like coconut oil, fractionated palm kernal oil, hydrogenated oils such as soybean or cottonseed or combinations of the above and vanillin. Compound chocolate has economic advantages over standard of identity chocolate because cocoa butter costs more than vegetable oils. The melting point characteristics of the fats used in compound chocolate may also affect the flavor delivery in frozen or refrigerated products. The lower the melt point, the quicker the flavor release when dissolved in the mouth. An alkanization process to the cocoa nibs, chocolate liquor, or cocoa may also affect the compound chocolate flavor and color. The compound chocolate coatings are used to coat ice cream cone coatings and many enrobed cookies, bars and snacks.

Compound chocolate may also be made in a sugar free form. Formulations for sugar free would likely include the addition of polyols as the primary sweetener instead of sugar or dextrose i.e., maltitol, erythritol, mannitol, or sorbitol. They could also use high intensity sweeteners like aspartame, sucralose, or acelsufame potassium to enhance the sweetness further. Other ingredients could be delactosed milk protein, salt, vanillin and lecithin.

Chocolate is not the only flavor of inclusion that may be formulated in this way. Using an approach similar to compound chocolate, alternate flavors may be achieved by replacing the cocoa solids with that of dried or powdered fruits or flavors, sugar, acids, salt, etc. They would likely use some other fat or oil as opposed to cocoa butter like coconut oil, fractionated palm kernal oil, hydrogenated vegetable oils, etc. Examples of other flavored compounds could be butterscotch, caramel, strawberry, or vanilla and others flavored inclusions.

For a bittersweet chocolate inclusion taste, the chocolate mixture used in the methods of the present invention contains very little soluble solids so that it will not dissolve when in the yogurt. Accordingly, the chocolate contains very little to no sugar or salt. The chocolate used in accordance with the present invention preferably contains less than 20% and preferably less than 10% and even more preferable less than 5% sugar, by weight, and preferably little or no added salt. The texture of the chocolate inclusion maintains its brittle texture without becoming too soft or chewy. A preferred chocolate mixture in the present invention comprises a ratio of about 65% chocolate liquor and about 35% cocoa butter.

For a more a sweet chocolate or milk chocolate taste that appeals to many Americans, the chocolate composition may include lower levels of chocolate liquor, addition of sugar up to 35% addition of milk powder up to about 10%, and about 50% to 60% cocoa butter. For a more American tasting compound chocolate, the composition may include up to 12% cocoa powder, up to 35% sugar and up to 10% milk powder and about 50% to 60% vegetable oil. The vegetable oils may include blends of coconut palm kernel and soybean oils. Oil blends may include lower melt point oil sources, which will melt more readily in the mouth. Total soluble solids content should be maintained as low as possible to preserve the integrity of the inclusion, preferably below 40%, and more preferably below 30%, and more preferably below 20%. Lecithin may be added to regulate and optimize the viscosity of the chocolate for injection.

The most desirable way to add chocolate pieces to yogurt, from a yogurt manufacturers standpoint, would be to introduce an aseptic flavor filling which contains both the fruit and or the flavoring material for the yogurt and the solidified pieces of chocolate. Yogurt manufacturers are familiar with the aseptic stainless steel type of package that aseptic fillings come in and the process for pumping that filling under clean environmental conditions to the yogurt mixing process. By having the fruit or flavoring material and the pre-formed pieces of chocolate all in one, this method would simplify yogurt-making operation for the manufacturers. The typical usage level for aseptic fruit or flavor fillings into yogurt is 10-25% by weight. When a filling that contains 15 to 20% chocolate inclusions is dosed at 10 to 25% into yogurt, the resulting chocolate inclusion content in the yogurt is 1.5 to 5%. This is a desirable level of chocolate in the yogurt from an organoleptic and cost standpoint. Alternately, an aseptic slurry of chocolate pieces in a sweetener syrup could be made separately from the aseptic fruit filling. Then, if a fruit and chocolate flavored filling is desired, the yogurt manufacturer would be required to pump 2 aseptic fillings simultaneously to the yogurt mixing process—the aseptic fruit filling and the aseptic filling containing the chocolate pieces. Fruit fillings are made in a concentrated form of the fruit or flavor they contain. When they are added to yogurt, they provide the correct amount of ingredients for the sensory characteristics: flavor, color, eye appeal, and so forth. The typical usage level for aseptic fruit or flavor fillings into yogurt is 10-25% by weight. By injecting 2 different inclusion streams, i.e. 1) fruit or flavor filling and 2) aseptic slurry with chocolate pieces, the usage level is likely to be higher thereby incurring higher costs to the yogurt manufacturer. When a filling that contains 15 to 20% chocolate inclusions is dosed at 10 to 25% into yogurt, the resulting chocolate inclusion content in the yogurt is 1.5 to 5%. This is a desirable level of chocolate in the yogurt from an organoleptic and cost standpoint.

The preferred method of incorporating chocolate into an aseptic filling involves combining two different streams of pasteurized fillings. The first stream is a standard aseptic fruit or flavor filling which has been chilled down to less than 50° F., preferably under 40° F. or 30° F. Standard yogurt fillings today are normally cooled to 85-105° F. prior to packaging. There are several reasons for not cooling the fillings down further such as excessive processing backpressures, breakdown of the stabilization systems, cooling capacities, etc. The soluble solids content of the filling formulation would be high enough to reduce the freezing point down to less than 20° F. Generally at 30% solids or higher, the freezing point of the filling is suppressed to less than 20° F. A 40% or higher solids content to the yogurt filling or neutral chocolate inclusion stabilized syrup mixture is preferred because it reduces the apparent viscosity even at temperatures as low as 20° F.

The second stream is made from pre-pasteurized melted chocolate that has been cooled to approximately 85-90° F. The chocolate for this stream would be melted, and pre-pasteurized at approximately 175° F. for 5 minutes and then pumped and cooled through heat exchangers to 85-90° F. The second stream would then be pumped into the first stream through an injection port at approximately 15 or 20% by weight. As the chocolate loses heat to the first stream, it will crystallize and harden. Static or mechanical mixers may be employed to break the chocolate into the proper size fragments. Care must be taken to not apply too much shear or agitation until after the chocolate injection has crystallized.

The pasteurized chocolate is solidified into pieces when the chocolate is injected into the chilled aseptic product. The product temperature may range from around 32° F. to 40° F. down to 20° F. It is readily appreciated that the colder the temperature of the chilled filling, the more rapidly the chocolate will harden. The soluble solids content of the filling results in a freezing point depression, which allows the filling to be chilled to temperatures below the normal freezing point of water. The solids content of the filling is generally around 30% or higher. Another factor that is taken into consideration when determining how rapidly the chocolate will harden is the rise in temperature the filling will experience when the melted chocolate (approximately 80° F. to 90° F.) is injected into the chilled filling. The filling could experience a rise in temperature of approximately 20° F. when the chocolate or chocolate compound injection rate is 15 to 20% by weight.

The shape and size of the chocolate pieces formed in the filling are dependent on the degree of shear or agitation that the chocolate experiences before the integrity of the crystallized chocolate has developed. If too much agitation occurs, some of the chocolate will be blended into the chilled filling in a homogenous state. Another factor in establishing the size of the chocolate particulates is the injection nozzle pattern and deposit rate of the chocolate within the chilled aseptic filling stream and the inline mixing device used to break the hardened chocolate within the fruit or flavor stream.

A second way this two-stream method may be accomplished is to inject the melted chocolate into a higher solids stream at a concentration of 20-30% to form a concentrated chocolate particulate slurry. This higher solids stream could be made from high fructose corn syrup or other sweetener syrup at 60% solids or higher. It is desirable to have the Aw below 0.7 and a pH below 4.6. In this way the freezing point would be very suppressed to as low as 0° F. or lower. This concentrated stream of chocolate particulates would be then pumped into another aseptic stream which constitutes the remainder of the yogurt filling. The concentrated chocolate stream would be blended at a ratio of 75% or 50% of the final filling to achieve a filling chocolate particulate content of 15%. The formulation of each stream would complement one another to make the proper proportions to achieve the desired final formulation.

A third way this two-stream method may be carried out could be to prepackage the two streams in an aseptic state in stainless steel rigid totes. The totes may then be refrigerated and blended at a later time to the proper proportion. The totes with the two different compositions could then be connected together with chemically sterilized hoses or pipes. Aseptic pumps could be introduced to assist in moving the two aseptic streams at the correct proportions to a pre-sterilized aseptic tote.

Another way chocolate pieces may be added yogurt in accordance with the present invention is to prepare the chocolate pieces in a dry particulate form whereby the chocolate pieces and package are sterilized by some other means other than thermal pasteurization. It may not be necessary for the pre-formed chocolate pieces to be pasteurized if the chocolate pieces are added to a filling that has a pH below 4.6 and or an Aw below 0.70. It is known that these product environments will control and cause the destruction of pathogens over a time period. The chocolate to be used in a process such as this could likely be pre-pasteurized to eliminate the bulk of the vegetative microorganisms. The chocolate pieces or flakes could then be formed by any method known for preparing chocolate pieces i.e., flakes, drops or chunks. Once formed, the chocolate pieces may go through another pasteurization step before the chocolate is added to the yogurt although pasteurization step could eliminated if product pH and or A_{w} environments would control microbial proliferation. Alternate forms of post pasteurization include ozone treatment, irradiation, or freezing.

One preferred method for forming chocolate flakes consists of sheeting the liquid chocolate onto a belt that travels through a chilling tunnel. Once the chocolate has solidified on the belt, the chocolate may be gathered, broken and sorted to the correct size and then filled into an open top plastic bag. Since the chocolate has been re-contaminated with environmental contaminations within the particulate or flake forming and packaging process, it could require some additional cold pasteurization intervention. After the chocolate has been cold sterilized and sealed within the bag, it may then be placed into protective carton and shipped to yogurt manufacturer. The yogurt manufacturer would simply cut the bag allowing chocolate particulates to fall into vat of chilled cultured yogurt.

In accordance with the present invention, the chocolate pieces could be sterilized by any method other than thermal pasteurization, which would melt the chocolate pieces. One particularly suitable cold pasteurization technique is the treatment of the chocolate pieces with ozone gas just prior to enacting a hermetic seal to the open top of the bag. Exposure times and concentrations may readily be determined by one of ordinary skill in the art. Flavor acceptability may, however, be an issue with ozone reaction with chocolate by creating a bitter taste profile.

A second suitable method of cold sterilization is irradiation of the chocolate pieces. In this case the chocolate particulates or flakes would be hermetically sealed in the plastic bag. The bag of flakes would then be passed by a radioactive source for the proper amount of exposure, which may be determined by one of skill in the art. One practical consideration when using this method is that the product then requires labeling indicating the product was irradiated thereby carrying marketing resistance.

A third suitable method of cold sterilization consists of freezing the chocolate pieces at a sufficient temperature for a sufficient length of time to kill any bacteria in the chocolate. The chocolate would be frozen, preferably to 0° F., for a sufficient period of time to kill the bacteria. One skilled in the art may readily determine the length of time the chocolate should be maintained at freezing temperatures to achieve the desired level of sterility.

A fourth suitable method for introduction of pre-formed chocolate to yogurt fillings or yogurt is to add the non-pasteurized chocolate pieces to the yogurt filling or yogurt. This may be considered a safe process for adding chocolate to yogurt as long as the time spent in the yogurt filling or yogurt were of such time that would allow for destruction of pathogens and the yeast and mold spoilage potential was controlled by the introduction of preservatives such as potassium sorbate at levels of 0.02 to 0.2%, sodium benzoate at levels of 0.02 to 0.2%, or sorbic acid at levels of 0.02 to 0.2% or combinations of these preservatives in these usage level ranges.

### EXAMPLES

Example 1 is an example of a fruit based filling for yogurt. The following ingredients were used to prepare the filling.

TABLE 1
Strawberry filling for strawberry - chocolate chip
flavored yogurt.

| Ingredient | % (weight) | Solids |
|---|---|---|
| Strawberries | 36.00 | 8.41 |
| Citric Acid | 0.05 | 0.05 |
| Malic Acid - Powdered | 0.05 | 0.05 |
| Sodium Citrate - Fine Granular | 0.10 | 0.10 |
| Potassium Sorbate | 0.03 | 0.03 |
| Sugar - Granulated | 9.34 | 9.34 |
| Isosweet Corn Syrup - 80% | 24.50 | 19.60 |
| Calcium Lactate Pentahydrate | 0.10 | 0.10 |
| Sodium Benzoate | 0.03 | 0.03 |
| Pectin | 0.50 | 0.50 |
| Water | 10.00 | 0.00 |
| Water | 15.00 | 0.00 |
| Staley Soft Set Starch | 0.50 | 0.46 |
| Frigex W Starch | 1.5 | 1.50 |
| Water | 2.30 | 0.00 |
| Total | 100.00 | 40.17 |

Briefly, the strawberries, acids, citrate, lactate and high fructose corn syrup were added to a kettle. The sorbate and benzoate were dissolved in water and added to the kettle.

A starch slurry was prepared by adding the water and starches to a blender and blending 5 minutes. The starch slurry was then added to the kettle.

The contents of the kettle were then heated to 160° F. (71° C.). While heating, the sugar was added slowly, and allowed to dissolve.

A pectin solution was prepared by adding 190° F. (88° C.) water and the pectins to a blender and blending for 5 minutes. The pectin solution was then added to the kettle.

The mixture in the kettle was then heated to 190° F. (88° C.) and held at that temperature for 5 minutes. It was then cooled to 120° F. (49° C.) and standardized.

The finished strawberry filling was cooled to 100° F. (38° C.) and packaged. The finished strawberry filling had a brix of 40.80 and a pH of 3.84. The freezing point of the filling was about 18 to 20° F. (−7 to −8° C.) measured visually. The finished strawberry filling was cooled and injected with chocolate at a level of 15% by the two-stream method outlined above.

Example 2 is an example of a neutral chocolate-containing filling for yogurt.

The following ingredients were used to prepare a neutral chocolate-containing filling. In this example, no flavor or color is added to the filling. Any desired flavor and color may be added directly to the yogurt as discussed above. For example, for a chocolate cheesecake flavored yogurt, the cheesecake flavoring would be added directly to the yogurt, as discussed in the specification, above.

TABLE 2
Neural filling for delivering chocolate chips to yogurt.

| Ingredient | % (weight) | Solids |
|---|---|---|
| Water | 36.600 | 0.000 |
| Potassium Sorbate | 0.030 | 0.030 |
| Sodium Benzoate | 0.030 | 0.030 |
| Sodium Citrate | 0.050 | 0.050 |
| Sugar - Granulated | 13.300 | 13.300 |
| Isosweet Corn Syrup - 80% | 16.725 | 13.380 |
| Citric Acid | 0.050 | 0.050 |
| Malic Acid - Powdered | 0.050 | 0.050 |
| Calcium Lactate Pentahydrate | 0.065 | 0.065 |
| Water | 15.000 | 0.000 |
| Pectin YF-310 | 0.300 | 0.285 |
| Pectin YF-410 | 0.300 | 0.300 |
| Water | 15.000 | 0.000 |
| Staley Soft Set Starch | 0.500 | 0.460 |
| Frigex W Starch | 2.000 | 2.000 |
| Total | 100.000 | 30.000 |

Briefly, water, benzoate, and citrate were added to a kettle. The sugar and high fructose corn syrup were then added.

A starch slurry was prepared by adding water and the starches to a blender and blending 5 minutes. The starch slurry was then added to the kettle. The resulting mixture was heated to 160° F. (71° C.).

A pectin solution was prepared by adding 190° F. (88° C.) water and the pectins to a blender and blending 5 minutes. The pectin solution was then added to the kettle, and the mixture in the kettle was then heated to 190° F. (88° C.) and held at that temperature for 5 minutes.

The mixture was then cooled to 120° F. (49° C.) and standardized. The mixture was then cooled to 90° F. (32° C.) and packaged. The finished filling had a brix of 30.40; a pH of 4.14. The resulting filling was then further chilled, and chocolate was injected at a level of 15% in accordance with the two stream method outlined above. The pH of the filling after addition of chocolate chips was 4.18.

Example 3 is a laboratory scale preparation of a neutral high solids chocolate-containing filling.

TABLE 3
High solids filling for delivering chocolate chips to yogurt.

| Ingredient | % (weight) | Solids |
|---|---|---|
| Isosweet Corn Syrup - 80% | 95.8 | 76.64 |
| Citric Acid | 0.08 | 0.08 |
| Sodium Benzoate | 0.03 | 0.03 |
| Potassium Sorbate | 0.03 | 0.03 |
| Xanthan Gum Keltrol F | 0.05 | 0.0475 |
| Xanthan Gum Keltrol F | 0.1 | 0.095 |
| Vicogum Locust Bean Gum | 0.05 | 0.05 |
| Water | 3.86 | |
| Total | 100.00 | 76.793 |

The filling of Example 3 was prepared as follows. The high fructose corn syrup was combined with the water. The xanthan gum and locust bean gum were added to the high fructose corn syrup/water mixture, while mixing with minimum agitation to maintain a vortex. The resulting mixture was mixed for 2 minutes.

The potassium sorbate and sodium benzoate were added to the mixture, and the resulting mixture was heated to 190° F. and maintained at 190° F. for 10 minutes. The mixture was then cooled to 50° F. in an ice bath, with occasional stirring, followed by cooling to 20° F. in a freezer.

The cooled mixture was placed in a mixer equipped with a wire whip and chocolate was added to a level of 15% (wt.), heated to 85° F. was slowly added to the mixture.

The examples included herein are for illustration and are not meant to limit the scope of the invention.

The invention claimed is:

1. A method of adding lipid-based inclusions to a filling suitable for flavoring yogurt, comprising the steps of
a) providing a filling, the filling having a pH of less than 4.6; and
b) adding the lipid-based inclusions to the filling;
wherein the lipid-based inclusions maintain physical integrity and microbiological stability when the filling is incorporated into yogurt.

2. The method of claim 1 wherein the filling of step a has a pH of less than 4.2.

3. The method of claim 2 wherein the filling of step a has a pH of less than 4.

4. The method of claim 1 wherein the filling has a water activity (A_{w}) of less than 0.75.

5. The method of claim 4 wherein the filling has an A_{w} of less than 0.7.

6. The method of claim 5 wherein the filling has an A_{w} of less than 0.65.

7. The method of claim 1 wherein the filling is a pasteurized filling or an aseptic filling.

8. The method of claim 1 wherein the filling is selected from the group consisting of fruit fillings and non-fruit fillings.

9. The method of claim 1 wherein the lipid-based inclusions are selected from the group consisting of chocolate, chocolate compound coatings, butterscotch, caramel, fruit-flavored, and combinations thereof.

10. The method of claim 9 wherein the inclusions are selected from the group consisting of chips, flakes, chunks, or combinations thereof.

11. The method of claim 1 wherein the lipid-based inclusions are added to the filling at a level of 15 to 20% by weight.

12. The method of claim 1 wherein the lipid-based inclusions have been pasteurized prior to being added to the filling.

13. A method of delivering microbiologically safe lipid-based inclusions to yogurt comprising the steps of
a) providing a filling for yogurt, wherein the filling has been pasteurized or aseptically processed;
b) providing a lipid-based mixture that will be used to form the lipid-based inclusions;
c) heating the lipid-based mixture to a temperature sufficient for pasteurization for an amount of time sufficient to pasteurize the lipid-based mixture;
d) chilling the aseptically processed filling to a temperature below the temperature required to crystallize the lipid-based mixture;
e) injecting a stream of the heated lipid-based mixture into the chilled filling to form a mixture of filling and lipid-based mixture, wherein the stream of the heated lipid-based mixture is added to the filling in a manner which minimizes exposure to environmental contamination with microbes, and wherein the lipid-based mixture crystallizes in the filling; and
f) agitating the mixture of step e to form the inclusions.

14. The method of claim 13 wherein the filling of step a has a pH of less than 4.2.

15. The method of claim 14 wherein the filling of step a has a pH of less than 4.

16. The method of claim 13 wherein the filling has an A_{w} of less than 0.75.

17. The method of claim 16 wherein the filling has an A_{w} of less than 0.7.

18. The method of claim 17 wherein the filling has an A_{w} of less than 0.65.

19. The method of claim 13 wherein the filling is chilled to less than 50° F.

20. The method of claim 19 wherein the filling is chilled to less than 40° F.

21. The method of claim 20 wherein the filling is chilled to less than 30° F.

22. The method of claim 13 wherein the filling is a fruit-flavored filling or a non-fruit flavored filling.

23. The method of claim 13 wherein the lipid-based inclusions are selected from the group consisting of chocolate, chocolate compound coating, butterscotch, caramel, fruit-flavored, and combinations thereof.

24. The method of claim 13 wherein the lipid-based mixture is added to the filling in the range from 15 to 20% by weight.

25. The method of claim 13 further comprising the step of packaging the filling with yogurt.

26. The method of claim 13 further comprising the step of blending the filling with yogurt.

27. A method of delivering lipid-based inclusions to yogurt comprising the steps of:
a) providing a filling for yogurt, wherein the filling has a pH of 4.6 or less;
b) chilling the filling to a temperature below the temperature required to crystallize the lipid-based inclusions;
c) providing a lipid-based melt that will form the inclusions when crystallized;
d) injecting the lipid-based melt into the chilled filling;
e) allowing the lipid-based melt to at least partially solidify in the chilled filling; and
f) agitating the mixture of step e to form the lipid-based inclusions in the filling;
wherein the lipid-based inclusions maintain physical integrity and microbiological stability when the filling is incorporated into yogurt.

28. The method of claim 27 wherein the filling has been chilled to less than 50° F.

29. The method of claim 28 wherein the filling has been chilled to less than 40° F.

30. The method of claim 29 wherein the filling has been chilled to less than 30° F.

31. The method of claim 27 wherein the filling is selected from fruit flavored fillings and non-fruit flavored fillings.

32. The method of claim 27 wherein the inclusions are selected from the group consisting of chocolate, chocolate compound coatings, butterscotch, caramel, fruit-flavored, and combinations thereof.

33. The method of claim 27 wherein the lipid-based mixture is added to the filling in the range from 15 to 20% by weight.

34. The method of claim 27 further comprising the step
g) blending the filling of step f with yogurt to form a yogurt containing lipid-based inclusions.

35. The method of claim 34 wherein the yogurt contains from 1.5 to 5% lipid-based inclusions by weight.

36. The method of claim 27 further comprising the step
g) packaging the filling of step f with yogurt.

37. The method claim 36 wherein the yogurt contains from 1.5 to 5% lipid-based inclusions by weight.

38. A method of delivering lipid-based inclusions to yogurt comprising the steps of
a) providing filling for yogurt, wherein the filling is a high solids syrup mix having a water activity (A_{w}) of less than 0.75;
b) chilling the filling to a temperature below the temperature required to crystallize the lipid-based inclusions;
c) providing a lipid-based melt that will form the inclusions when crystallized;
d) injecting the lipid-based melt into the chilled filling;
e) allowing the lipid-based melt to at least partially solidify in the chilled filling; and
f) agitating the mixture of step e to form the lipid-based inclusions in the filling.

39. The method of claim 38 wherein the filling has an A_{w} of less than 0.7.

40. The method of claim 39 wherein the filling has an A_{w} of less than 0.65.

41. The method of claim 38 wherein the pH of the filling is less than 4.6.

42. The method of claim 41 wherein the pH of the filling is less than 4.2.

43. The method of claim 42 wherein the pH of the filling is less than 4.0.

44. The method of claim 38 wherein the filling is chilled to less than 50° F.

45. The method of claim 44 wherein the filling is chilled to less than 40° F.

46. The method of claim 45 wherein the filling is chilled to less than 30° F.

47. The method of claim 38 wherein the filling is a fruit based filling or a non-fruit based filling.

48. The method of claim 38 wherein the lipid-based inclusions are selected from the group consisting of chocolate, chocolate compound coating, butterscotch, caramel, fruit-flavored, and combinations thereof.

49. The method of claim 48 wherein the lipid-based inclusions are selected from the group consisting of chocolate, chocolate compound coating and combinations thereof.

50. The method of claim 49 wherein the lipid-based inclusions are added to the filling in the range from 15 to 20% by weight.

51. The method of claim 38 further comprising the step
g) blending the filling of step f with yogurt to form a yogurt containing lipid-based inclusions.

52. The method of claim 51 wherein the yogurt contains from 1.5 to 5% lipid-based inclusions by weight.

53. The method of claim 38 further comprising the step
g) packaging the filling of step f with yogurt.

54. The method claim 53 wherein the yogurt contains from 1.5 to 5% lipid-based inclusions by weight.

55. A filling for yogurt comprising a filling base having a pH of less than 4.6 and lipid-based inclusions dispersed therein.

56. The filling of claim 55 wherein the pH is less than 4.2.

57. The filling of claim 56 wherein the pH is less than 4.0

58. The filling of claim 55 wherein the A_{w} is less than 0.75.

59. The filling of claim 58 wherein the A_{w} is less than 0.7.

60. The filling of claim 59 wherein the A_{w} is less than 0.65

61. The filling of claim 55 wherein the filling base is pasteurized or aseptic.

62. The filling of claim 55 wherein the lipid-based inclusions are selected from the group consisting of chocolate, compound chocolate, butterscotch, caramel, fruit-flavored, and combinations thereof.

63. The filling of claim 62 wherein the lipid-based inclusions are selected from the group consisting of chocolate, chocolate compound coating and combinations thereof.

64. The filling of claim 63 wherein the filling comprises 15-20% inclusions by weight.

65. The filling of claim 55 wherein the filling is a fruit based filling or a non-fruit filling.
